(19) United States
(12) Patent Application Publication
(10) Pub. No.: US 2020/0077656 A1
(43) Pub. Date: Mar. 12, 2020

(54) Use of an Acyclic Picolinamide Compound as a Fungicide for Control of Phytopathogenic Fungi in Row Crops

(71) Applicant: Dow AgroSciences LLC, Indianapolis, IN (US)

(72) Inventors: Courtney Gallup, Davenport, IA (US); Yi-Hsiou Huang, Pingtung County, Taiwan (CN); Akos Biro, Budapest (HU); Chenglin Yao, Westfield, IN (US); Kevin G Meyer, Zionsville, IN (US); Luis Claudio Vieira Da Cunha, Sao Paulo City (BR); Mark Fairfax, Warwick (GB); Brian Husband, New Plymouth (NZ); John Richburg, Headland, AL (US); Marsha Martin, Columbus (IN)

(73) Assignee: Dow AgroSciences LLC, Indianapolis, IN (US)

(21) Appl. No.: 16/610,111

(22) PCT Filed: May 2, 2018
(86) PCT No.: PCT/US2018/030556

§ 371 Date: Nov. 1, 2019

Related U.S. Application Data
(60) Provisional application No. 62/500,179, filed on May 2, 2017.

(51) Int. Cl. A01N 43/40

(52) U.S. Cl. CPC A01N 43/40

(57) ABSTRACT

The present disclosure is related to the field of agrochemicals, including compound I and its use to control fungal diseases in agriculturally useful row crops.

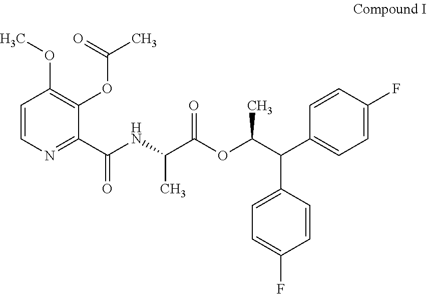 [SMILES: COc1ccnc(C(=O)N[C@@H](C)C(=O)O[C@@H](C)C(c2ccc(F)cc2)c2ccc(F)cc2)c1OC(C)=O]

### CROSS-REFERENCE TO RELATED APPLICATIONS

This is a national phase entry under 35 U.S.C. § 371 of international patent application PCT/US18/030556, filed on May 2, 2018 and published in English as international patent publication WO2018204434 on Nov. 8, 2018, which claims the benefit of U.S. Provisional Patent Application Ser. No. 62/500,179 filed May 2, 2017, which is expressly incorporated by reference herein.

### FIELD

This present disclosure is related to the field of the use of (S)-1,1-bis(4-fluorophenyl)propan-2-yl (3-acetoxy-4-methoxypicolinoyl)-L-alaninate to control fungal diseases in row crops.

### BACKGROUND AND SUMMARY

Fungicides are compounds, of natural or synthetic origin, which act to protect and cure plants against damage caused by agriculturally-relevant fungi. Generally, no single fungicide is useful in all situations. Consequently, research is ongoing to produce fungicides that may have better performance, are easier to use, and cost less.

The present disclosure relates to (S)-1,1-bis(4-fluorophenyl)propan-2-yl (3-acetoxy-4-methoxypicolinoyl)-L-alaninate (compound I) and its use as a fungicide. Compound I may offer protection against ascomycetes, basidiomycetes, and deuteromycetes.

One embodiment of the present disclosure includes a method of controlling a pathogen-induced disease in a plant that is at risk of being diseased from the pathogen comprising contacting the plant or an area adjacent to the plant with a composition including compound I.

Another embodiment of the present disclosure is a use of compound I for protection of a plant against attack by a phytopathogenic organism or the treatment of a plant infested by a phytopathogenic organism, comprising the application of compound I, or a composition including compound I to soil, a plant, a part of a plant, foliage, and/or seeds.

Additionally, another embodiment of the present disclosure is a composition useful for protecting a plant against attack by a phytopathogenic organism and/or treatment of a plant infested by a phytopathogenic organism comprising compound I and a phytologically acceptable carrier material.

### DETAILED DESCRIPTION

One exemplary embodiment of the present disclosure includes mixture for controlling the growth of fungi, the mixture including compound I:

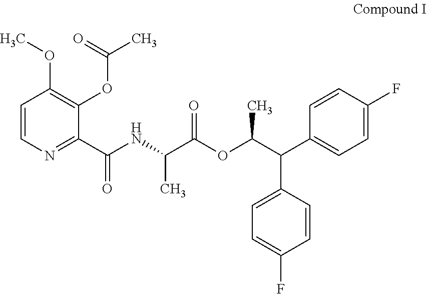 [SMILES: COc1ccnc(C(=O)N[C@@H](C)C(=O)O[C@@H](C)C(c2ccc(F)cc2)c2ccc(F)cc2)c1OC(C)=O]

Compound I of the present disclosure may be applied by any of a variety of known techniques, either as compound I or as formulations comprising compound I. For example, compound I may be applied to the roots, stems, seeds, flowers, or foliage of plants for the control of various fungi, without damaging the commercial value of the plants. Compound I may also be applied as a foliar spray, chemigation, soil spray, soil incorporation, soil drench, soil injection, or seed treatment. The material may be applied in the form of any of the generally used formulation types, for example, as solutions, dusts, wettable powders, flowable concentrates, or emulsifiable concentrates.

Preferably, compound I of the present disclosure is applied in the form of a formulation, including compound I with a phytologically acceptable carrier. Concentrated formulations may be dispersed in water or other liquids for application, or formulations may be dust-like or granular, which may then be applied without further treatment. The formulations can be prepared according to procedures that are conventional in the agricultural chemical art.

The present disclosure contemplates all vehicles by which compound I may be formulated for delivery and use as a fungicide. Typically, formulations are applied as aqueous suspensions or emulsions. Such suspensions or emulsions may be produced from water-soluble, water-suspendible, or emulsifiable formulations which are solids, usually known as wettable powders; or liquids, usually known as emulsifiable concentrates, aqueous suspensions, or suspension concentrates. As will be readily appreciated, any material to which compound I may be added may be used, provided it yields the desired utility without significant interference with the activity of compound I as an antifungal agent.

Wettable powders, which may be compacted to form water-dispersible granules, comprise an intimate mixture including compound I, an inert carrier and surfactants. The concentration of compound I in the wettable powder may be from about 10 percent to about 90 percent by weight based on the total weight of the wettable powder, more preferably about 25 weight percent to about 75 weight percent. In the preparation of wettable powder formulations, compound I may be compounded with any finely divided solid, such as prophyllite, talc, chalk, gypsum, Fuller's earth, bentonite, attapulgite, starch, casein, gluten, montmorillonite clays, diatomaceous earths, purified silicates or the like. In such operations, the finely divided carrier and surfactants are typically blended with compound I and milled.

Emulsifiable concentrates of compound I may comprise a convenient concentration, such as from about 10 weight percent to about 50 weight percent of compound I, in a suitable liquid, based on the total weight of the concentrate. Compound I may be dissolved in an inert carrier, which is either a water-miscible solvent or a mixture of water-immiscible organic solvents, and emulsifiers. The concentrates may be diluted with water and oil to form spray mixtures in the form of oil-in-water emulsions. Useful organic solvents include aromatics, especially the high-boiling naphthalenic and olefinic portions of petroleum, such as heavy aromatic naphtha. Other organic solvents may also be used, for example, terpenic solvents, including rosin derivatives, aliphatic ketones, such as cyclohexanone, and complex alcohols, such as 2-ethoxyethanol.

Emulsifiers which may be advantageously employed herein may be readily determined by those skilled in the art and include various nonionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulphonic acids, oil-soluble salts or sulfated polyglycol ethers and appropriate salts of phosphated polyglycol ether.

Representative organic liquids which may be employed in preparing the emulsifiable concentrates of compound I of the present invention are the aromatic liquids such as xylene, propyl benzene fractions; or mixed naphthalene fractions, mineral oils, substituted aromatic organic liquids such as dioctyl phthalate; kerosene; dialkyl amides of various fatty acids, particularly the dimethyl amides of fatty glycols and glycol derivatives such as the n-butyl ether, ethyl ether or methyl ether of diethylene glycol, and the methyl ether of triethylene glycol and the like. Mixtures of two or more organic liquids may also be employed in the preparation of the emulsifiable concentrate. Organic liquids include xylene, and propyl benzene fractions, with xylene being most preferred in some cases. Surface-active dispersing agents are typically employed in liquid formulations and in an amount of from 0.1 to 20 percent by weight based on the combined weight of the dispersing agent with compound I. The formulations can also contain other compatible additives, for example, plant growth regulators and other biologically active compounds used in agriculture.

Aqueous suspensions including compound I may be dispersed in an aqueous vehicle at a concentration in the range from about 5 to about 50 weight percent, based on the total weight of the aqueous suspension. Suspensions are prepared by finely grinding compound I, and vigorously mixing the ground material into a vehicle comprised of water and surfactants chosen from the same types discussed above. Other components, such as inorganic salts and synthetic or natural gums, may also be added to increase the density and viscosity of the aqueous vehicle.

Compound I may also be applied as a granular formulation, which is particularly useful for applications to the soil. Granular formulations generally contain from about 0.5 to about 10 weight percent, based on the total weight of the granular formulation of compound I, dispersed in an inert carrier which consists entirely or in large part of coarsely divided inert material such as attapulgite, bentonite, diatomite, clay or a similar inexpensive substance. Such formulations are usually prepared by dissolving compound I in a suitable solvent and applying it to a granular carrier which has been preformed to the appropriate particle size, in the range of from about 0.5 to about 3 mm. A suitable solvent is a solvent in which compound I is substantially or completely soluble. Such formulations may also be prepared by making a dough or paste of the carrier and compound I and solvent, and crushing and drying to obtain the desired granular particle.

Dusts containing compound I may be prepared by intimately mixing compound I in powdered form with a suitable dusty agricultural carrier, such as, for example, kaolin clay, ground volcanic rock, and the like. Dusts can suitably contain from about 1 to about 10 weight percent of compound I, based on the total weight of the dust.

The formulations may additionally contain adjuvant surfactants to enhance deposition, wetting and penetration of compound I onto the target crop and organism. These adjuvant surfactants may optionally be employed as a component of the formulation or as a tank mix. The amount of adjuvant surfactant will typically vary from 0.01 to 1.0 percent by volume, based on a spray-volume of water, preferably 0.05 to 0.5 volume percent. Suitable adjuvant surfactants include, but are not limited to ethoxylated nonyl phenols, ethoxylated synthetic or natural alcohols, salts of the esters or sulphosuccinic acids, ethoxylated organosilicones, ethoxylated fatty amines and blends of surfactants with mineral or vegetable oils. The formulations may also include oil-in-water emulsions such as those disclosed in U.S. patent application Ser. No. 11/495,228, the disclosure of which is expressly incorporated by reference herein.

In certain instances, it would be beneficial for formulations of compound I to be sprayed via an aerial application using aircraft or helicopters. The exact components of these aerial applications depends upon the crop being treated. Aerial applications for row crops utilize spray volumes preferably from 15 to 501 liters per hectare (L/ha) with standard surfactant, wetting, sticking, spreading or penetrating type additives such as non-ionic surfactants, organosilicones, or crop oil concentrates, preferably from 0.05 to 15 percent, based on a spray volume of water.

The formulations may optionally include combinations that contain other pesticidal compounds. Such additional pesticidal compounds may be spray additives such as non-ionic surfactants, organosilicones, and crop oils, fungicides, insecticides, herbicides, nematicides, miticides, arthropodicides, bactericides or combinations thereof that are compatible with the compounds of the present invention in the medium selected for application, and not antagonistic to the activity of the present compounds. Accordingly, in such embodiments, the other pesticidal compound is employed as a supplemental toxicant for the same or for a different pesticidal use. Compound I and the pesticidal compound in the combination can generally be present in a weight ratio of from 1:100 to 100:1.

Compound I of the present disclosure may also be combined with other fungicides to form fungicidal mixtures and synergistic mixtures thereof. Compound I of the present disclosure is often applied in conjunction with one or more other fungicides to control a wider variety of undesirable diseases. When used in conjunction with other fungicide(s), the presently claimed compound I may be formulated with the other fungicide(s), tank-mixed with the other fungicide(s) or applied sequentially with the other fungicide(s). Such other fungicides may include 2-(thiocyanatomethylthio)-benzothiazole, 2-phenylphenol, 8-hydroxyquinoline sulfate, ametoctradin, amisulbrom, antimycin, Ampelomyces quisqualis, azaconazole, azoxystrobin, Bacillus subtilis, Bacillus subtilis strain QST713, benalaxyl, benomyl, benthiavalicarb-isopropyl, benzylaminobenzene-sulfonate (BABS) salt, bicarbonates, biphenyl, bismerthiazol, bitertanol, bixafen, blasticidin-S, borax, Bordeaux mixture, boscalid, bromuconazole, bupirimate, calcium polysulfide, captafol, captan, carbendazim, carboxin, carpropamid, carvone, chlazafenone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, enestrobin, enestroburin, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluoxastrobin, fluquinconazole, flusilazole, flusulfamide, flutianil, flutolanil, flutriafol, fluxapyroxad, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), iodocarb, ipconazole, ipfenpyrazolone, iprobenfos, iprodione, iprovalicarb, isoprothiolane, isopyrazam, isotianil, kasugamycin, kasugamycin hydrochloride hydrate, kresoxim-methyl, laminarin, mancopper, mancozeb, mandipropamid, maneb, mefenoxam, mepanipyrim, mepronil, meptyl-dinocap, mercuric chloride, mercuric oxide, mercurous chloride, metalaxyl, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrametostrobin, pyraoxystrobin, pyrazophos, pyribencarb, pyributicarb, pyrifenox, pyrimethanil, pyriofenone, pyroquilon, quinoclamine, quinoxyfen, quintozene, Reynoutria sachalinensis extract, sedaxane, silthiofam, simeconazole, sodium 2-phenylphenoxide, sodium bicarbonate, sodium pentachlorophenoxide, spiroxamine, sulfur, SYP-Z048, tar oils, tebuconazole, tebufloquin, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, valifenalate, valiphenal, vinclozolin, zineb, ziram, zoxamide, Candida oleophila, Fusarium oxysporum, Gliocladium spp., Phlebiopsis gigantea, Streptomyces griseoviridis, Trichoderma spp., (RS)-N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme, aminopyrifen, ampropylfos, anilazine, azithiram, barium polysulfide, Bayer 32394, benodanil, benquinox, bentaluron, benzamacril; benzamacril-isobutyl, benzamorf, benzovindiflupyr, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, coumoxystrobin, cufraneb, cupric hydrazinium sulfate, cuprobam, cyclafuramid, cypendazole, cyprofuram, decafentin, dichlobentiazox, dichlone, dichlozoline, diclobutrazol, dimethirimol, dinocton, dinosulfon, dinoterbon, dipymetitrone, dipyrithione, ditalimfos, dodicin, drazoxolon, EBP, enoxastrobin, ESBP, etaconazole, etem, ethirim, fenaminosulf, fenaminstrobin, fenapanil, fenitropan, fenpicoxamid, fluindapyr, fluopimomide, fluotrimazole, flufenoxystrobin, furcarbanil, furconazole, furconazole-cis, furmecyclox, furophanate, glyodine, griseofulvin, halacrinate, Hercules 3944, hexylthiofos, ICIA0858, inpyrfluxam, ipfentrifluconazole, ipflufenoquin, isofetamid, isoflucypram, isopamphos, isovaledione, mandestrobin, mebenil, mecarbinzid, mefentrifluconazole, metazoxolon, methfuroxam, methylmercury dicyandiamide, metsulfovax, metyltetraprole, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, oxathiapiprolin, phenylmercury dimethyldithiocarbamate, phenylmercury nitrate, phosdiphen, picarbutrazox, prothiocarb; prothiocarb hydrochloride, pydiflumetofen, pyracarbolid, pyrapropoyne, pyraziflumid, pyridachlometyl, pyridinitril, pyrisoxazole, pyroxychlor, pyroxyfur, quinacetol, quinacetol sulfate, quinazamid, quinconazole, quinofumelin, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, triclopyricarb, triflumezopyrim, urbacid, zarilamid, and any combinations thereof.

Additionally, compound I of the present invention may be combined with other pesticides, including insecticides, nematicides, miticides, arthropodicides, bactericides or combinations thereof that are compatible with compound I of the present invention in the medium selected for application, and not antagonistic to the activity of compound I, to form pesticidal mixtures and synergistic mixtures thereof. Compound I of the present disclosure may be applied in conjunction with one or more other pesticides to control a wider variety of undesirable pests. When used in conjunction with other pesticides, the presently claimed compound I may be formulated with the other pesticide(s), tank mixed with the other pesticide(s) or applied sequentially with the other pesticide(s). Typical insecticides include, but are not limited to: antibiotic insecticides such as allosamidin and thuringiensin; macrocyclic lactone insecticides such as spinosad and spinetoram; avermectin insecticides such as abamectin, doramectin, emamectin, eprinomectin, ivermectin and selamectin; milbemycin insecticides such as lepimectin, milbemectin, milbemycin oxime and moxidectin; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dessicant insecticides such as boric acid, diatomaceous earth and silica gel; diamide insecticides such as broflanilide, chlorantraniliprole, cyantraniliprole, cyclaniliprole, cyhalodiamide, flubendiamide, tetrachlorantraniliprole, and tetraniliprole; diarylisoxazoline insecticides such as fluxametamide; dinitrophenol insecticides such as dinex, dinoprop, dinosam and DNOC; fluorine insecticides such as barium hexafluorosilicate, cryolite, sodium fluoride, sodium hexafluorosilicate and sulfluramid; formamidine insecticides such as amitraz, chlordimeform, formetanate and formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; mesoionic insecticides such as dicloromezotiaz and triflumezopyrim; moulting hormone agonists such as chromafenozide, halofenozide, methoxyfenozide and tebufenozide; moulting hormones such as α-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; pyridylpyrazole insecticides such as tyclopyrazoflor; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethyl-amine insecticides such as acetamiprid, cycloxaprid, imidacloprid, nitenpyram, and thiacloprid; organochlorine insecticides such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, alpha-endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephi on, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion fensulfothion, fenthion, fenthion-ethyl, heterophos, j odfenphos, mesulfenfos, parathion, parathion-methyl, phenkapton, phosnichlor, profenofos, prothiofos, sulprofos, temephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, isofenphos-methyl, methamidophos and propetamphos; phosphorodiamide insecticides such as dimefox, mazidox, mipafox and schradan; oxadiazine insecticides such as indoxacarb; oxadiazoline insecticides such as metoxadiazone; phthalimide insecticides such as dialifos, phosmet and tetramethrin; pyrazole insecticides such as tebufenpyrad, tolefenpyrad; phenylpyrazole insecticides such as acetoprole, ethiprole, fipronil, pyrafluprole, pyriprole and vaniliprole; pyrethroid ester insecticides such as acrinathrin, allethrin, bioallethrin, barthrin, bifenthrin, kappa-bifenthrin, bioethanomethrin, chloroprallethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, heptafluthrin, imiprothrin, meperfluthrin, metofluthrin, epsilon-metofluthrin, momfluorothrin, epsilon-momfluorothrin, permethrin, biopermethrin, transpermethrin, phenothrin, prallethrin, profluthrin, pyresmethrin, resmethrin, bioresmethrin, cismethrin, tefluthrin, kappa-tefluthrin, terallethrin, tetramethrin, tetramethylfluthrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetramic acid insecticides such as spiropidion and spirotetramat; tetronic acid insecticides such as spiromesifen; thiourea insecticides such as diafenthiuron; urea insecticides such as flucofuron and sulcofuron; unclassified nematicides such as fluazaindolizine and tioxazafen; and unclassified insecticides such as benzpyrimoxan, closantel, copper naphthenate, crotamiton, EXD, fenazaflor, fenoxacrim, fluhexafon, flupyrimin, hydramethylnon, isoprothiolane, malonoben, metaflumizone, nifluridide, oxazolsulfyl, plifenate, pyridaben, pyridalyl, pyrifluquinazon, rafoxanide, sulfoxaflor, triarathene and triazamate, and any combinations thereof.

Additionally, compound I of the present invention may be combined with herbicides that are compatible with compound I of the present invention in the medium selected for application, and not antagonistic to the activity of compound I to form pesticidal mixtures and synergistic mixtures thereof. The fungicidal compound I of the present disclosure may be applied in conjunction with one or more herbicides to control a wide variety of undesirable plants. When used in conjunction with herbicides, the presently claimed compound I may be formulated with the herbicide(s), tank mixed with the herbicide(s) or applied sequentially with the herbicide(s). Typical herbicides include, but are not limited to: amide herbicides such as allidochlor, beflubutamid, benzadox, benzipram, bromobutide, cafenstrole, CDEA, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid, tebutam and tiafenacil; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flamprop and flamprop-M; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor; sulfonanilide herbicides such as benzofluor, perfluidone, pyrimisulfan and profluazol; sulfonamide herbicides such as asulam, carbasulam, fenasulam and oryzalin; thioamide herbicides such as chlorthiamid; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid, florpyrauxifen, halauxifen, and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as fenquinotrione, lancotrione, mesotrione, sulcotrione, tefuryltrione and tembotrione; benzofuranyl alkylsulfonate herbicides such as benfuresate and ethofumesate; benzothiazole herbicides such as benzazolin; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such as imazamethabenz, imazamox, imazapic, imazapyr, imazaquin and imazethapyr; inorganic herbicides such as ammonium sulfamate, borax, calcium chlorate, copper sulfate, ferrous sulfate, potassium azide, potassium cyanate, sodium azide, sodium chlorate and sulfuric acid; nitrite herbicides such as bromobonil, bromoxynil, chloroxynil, cyclopyranil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glufosinate-P, glyphosate and piperophos; phenoxy herbicides such as bromofenoxim, clomeprop, 2,4-DEB, 2,4-DEP, difenopenten, disul, erbon, etnipromid, fenteracol and trifopsime; oxadiazoline herbicides such as methazole, oxadiargyl, oxadiazon; oxazole herbicides such as fenoxasulfone; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecoprop and mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazole herbicides such as pyroxasulfone; benzoylpyrazole herbicides such as benzofenap, pyrasulfotole, pyrazolynate, pyrazoxyfen, tolpyralate, and topramezone; phenylpyrazole herbicides such as fluazolate, nipyraclofen, pioxaden and pyraflufen; pyridazine herbicides such as credazine, cyclopyrimorate, pyridafol and pyridate; pyridazinone herbicides such as brompyrazon, chloridazon, dimidazon, flufenpyr, metflurazon, norflurazon, oxapyrazon and pydanon; pyridine herbicides such as aminopyralid, cliodinate, clopyralid, dithiopyr, florpyrauxifen, fluroxypyr, halauxifen, haloxydine, picloram, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate; thiocarbonate herbicides such as dimexano, EXD and proxan; thiourea herbicides such as methiuron; triazine herbicides such as dipropetryn, indaziflam, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron, metribuzin, and trifludimoxazin; triazole herbicides such as amitrole, cafenstrole, epronaz and flupoxam; triazolone herbicides such as amicarbazone, bencarbazone, carfentrazone, flucarbazone, ipfencarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as benzfendizone, bromacil, butafenacil, flupropacil, isocil, lenacil, saflufenacil, tiafenacil, and terbacil; urea herbicides such as benzthiazuron, cumyluron, cycluron, dichloralurea, diflufenzopyr, isonoruron, isouron, methabenzthiazuron, monisouron and noruron; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, nicosulfuron, orthosulfamuron, oxasulfuron, primisulfuron, propyrisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, iofensulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluron and thidiazuron; and unclassified herbicides such as acrolein, allyl alcohol, aminocyclopyrachlor, azafenidin, bentazone, benzobicyclon, bicyclopyrone, buthidazole, calcium cyanamide, cambendichlor, chlorfenac, chlorfenprop, chlorflurazole, chlorflurenol, cinmethylin, clomazone, CPMF, cresol, cyanamide, cyclopyrimorate, ortho-dichlorobenzene, dimepiperate, endothal, fluoromidine, fluridone, flurochloridone, flurtamone, fluthiacet, indanofan, methyl isothiocyanate, OCH, oxaziclomefone, pentachlorophenol, pentoxazone, phenylmercury acetate, prosulfalin, pyribenzoxim, pyriftalid, quinoclamine, rhodethanil, sulglycapin, thidiazimin, tridiphane, trimeturon, tripropindan and tritac.

Compound I of the present invention can also comprise or may be applied together and/or sequentially with further active compounds. These further compounds can be plant health stimulants, such as organic compounds, inorganic fertilizers, or micronutrient donors or other preparations that influence plant growth, such as inoculants.

In another embodiment, Compound I can also comprise or may be applied together and/or sequentially with other biological organisms, such as, but not limited to the group consisting of Bacillus strains, for example Bacillus subtilis var. amyloliquefaciens FZB24 (TAEGRP®) and Bacillus amyloliquefaciens FZB42 (RHIZOVITAL®), VotiVo™ Bacillus firmus, Clariva™ (Pasteuria nishizawae), Bacillus thuringiensis, Trichoderma spp., and/or mutants and metabolites of the respective strains that exhibit activity against insects, mites, nematodaes, and/or phytopathogens

One embodiment of the present disclosure is a method for the control or prevention of fungal attack. This method comprises applying to the soil, plant, roots, foliage, seed or locus of the fungus, or to a locus in which the infestation is to be prevented (for example applying to cereal or grape plants), a fungicidal effective amount of compound I. Compound I is suitable for treatment of various plants at fungicidal levels, while exhibiting low phytotoxicity. Compound I may be useful both in a protectant and/or an eradicant fashion.

The compound of Formula I has been found to have significant fungicidal effects particularly for agricultural use. The compound of Formula I is particularly effective for use with agricultural crops and horticultural plants. Additional benefits may include, but are not limited to, improving the health of a plant; improving the yield of a plant (e.g. increased biomass and/or increased content of valuable ingredients); improving the vigor of a plant (e.g. improved plant growth and/or greener leaves); improving the quality of a plant (e.g. improved content or composition of certain ingredients); and improving the tolerance to abiotic and/or biotic stress of the plant.

In particular, the composition is effective in controlling a variety of undesirable fungi that infect useful row crops. The composition maybe used against a variety of Ascomycete and Basidiomycete fungi, including, for example, the following representative fungi species:

On corn: Anthracnose (Colletotrichum graminicola, Glomerella tucumanensis), Aspergillus ear and kernel rot (Aspergillus flavus), banded leaf and sheath spot (Rhizoctonia solani, Rhizoctonia microsclerotia), black bundle disease (Acremonium strictum, Cephalosporium acremonium), black kernel rot (Marasmiellus spp.), brown spot, black spot, stalk rot (Physoderma maydis), Cephalosporium kernel rot (Acremonium strictum, Cephalosporium acremonium), charcoal rot (Macrophomina phaseolina), Corticium ear rot (Thanatephorus cucumeris, Corticium sasakii), Curvularia leaf spot (Curvularia spp.), Didymella leaf spot (Didymella exitalis), Diplodia ear rot, stalk rot, leaf spot, leaf streak (Diplodia spp.), dry ear rot, cob, kernel and stalk rot (Nigrospora oryzae), ear rots (Alternaria spp., Aspergillus spp., Botrytis cinerea, Fusarium culmorum, Cunninghamella spp., Curvularia pallescens, Rhizopus spp., Gonatobotrys simplex, Doratomyces stemonitis, Cephalotrichum stemonitis, Pithomyces maydicus, Scopulariopsis brumptii), ergot (Claviceps gigantea), eyespot (Aureobasidium zeae, Kabatiella zeae), Fusarium kernel, root and stalk rot, seed rot, stalk rot, ear rot, and seedling blight (Fusarium spp., Gibberella spp.), gray ear rot (Botryosphaeria zeae, Physalospora zeae), gray leaf spot, Cercospora leaf spot (Cercospora sorghi, Cercospora zeae-maydis), Helminthosporium root rot (Exserohilum pedicellatum, Helminthosporium pedicellatum), Cladosporium rot (Cladosporium spp.), leaf spots (Alternaria alternata, Ascochyta maydis, Ascochyta tritici, Ascochyta zeicola, Bipolaris victoriae, Helminthosporium victoriae, Cochliobolus victoriae, Cochliobolus sativus, Bipolaris sorokiniana, Epicoccum nigrum, Exserohilum prolatum, Drechslera prolata, Graphium penicillioides, Leptosphaeria maydis, Leptothyrium zeae, Ophiosphaerella herpotricha, Paraphaeosphaeria michotii, Phoma spp., Septoria spp.), Northern corn leaf blight (Setosphaeria turcica), white blast, stalk rot, stripe (Exserohilum turcicum, Helminthosporium turcicum), Northern corn leaf spot (Cochliobolus carbonum), Helminthosporium ear rot (Bipolaris zeicola, Helminthosporium carbonum), Penicillium ear rot, blue eye, blue mold (Pennicillium spp.), Phaeocytostroma stalk rot and root rot (Phaeocytostroma ambiguum, Phaeocytosporella zeae), Phaeosphaeria leaf spot (Phaeosphaeria maydis, Sphaerulina maydis), Physalospora ear rot, Botryosphaeria ear rot (Botryosphaeria festucae, Physalospora zeicola), Pyrenochaeta stalk rot and root rot (Phoma terrestris, Pyrenochaeta terrestris), red kernel disease, ear mold, leaf and seed rot (Epicoccum nigrum), Rhizoctonia ear rot, root rot, stalk rot (Rhizoctonia spp.), root rots (Alternaria alternata, Cercospora sorghi, Dictochaeta fertilis, Fusarium spp., Gibberella spp., Microdochium bolleyi, Mucor spp., Periconia circinata, Rhizopus arrhizus) Rostratum leaf spot, Helminthosporium leaf disease, ear and stalk rot (Setosphaeria rostrata, Helminthosporium rostratum), rusts (Puccinia spp., Physopella spp.), brown rust of corn (Puccinia polysora), Sclerotium ear rot, Southern blight (Sclerotium rolfsii), seed rot-seedling blight (Bipolaris spp., Helminthosporium spp., Diplodia maydis, Exserohilum spp., Fusarium spp., Gibberella spp., Macrophomina phaseolina, Penicillium spp., Phomopsis spp., Rhizoctonia spp., Sclerotium rolfsii, Spicaria spp.), Selenophoma leaf spot (Selenophoma sp.), sheath rot (Gaeumannomyces graminis), shuck rot (Myrothecium gramineum), silage mold (Monascus spp.), smuts (Ustilago spp., Ustilaginoidea vixens, Sphacelotheca reiliana, Sporisorium holci-sorghi), Southern corn leaf blight and stalk rot (Cochliobolus heterostrophus, Bipolaris maydis, Helminthosporium maydis), stalk rots (Cercospora sorghi, Fusarium spp., Nectria haematococca, Mariannaea elegans, Mucor spp., Rhopographus zeae, Spicaria spp.), storage rots (Aspergillus spp., Penicillium spp.), tar spot (Phyllachora maydis, Monographella maydis, Coniothyrium phyllachorae), Trichoderma ear rot and root rot (Trichoderma viride, Trichoderma lignorum, Hypocrea spp.), white ear rot, root and stalk rot (Stenocarpella maydis, Diplodia zeae), yellow leaf blight (Ascochyta ischaemi, Phyllosticta maydis, Mycosphaerella zeae-maydis) and Zonate leaf spot (Gloeocercospora sorghi);

On soybean: Alternaria leaf spot (Alternaria spp.), anthracnose (Colletotrichum truncatum, Colletotrichum dematium f. truncatum, Glomerella glycines), black leaf blight (Arkoola nigra), black root rot (Thielaviopsis basicola, Chalara elegans), brown spot (Septoria glycines, Mycosphaerella usoenskajae), brown stem rot (Phialophora gregata, Cephalosporium gregatum), charcoal rot (Macrophomina phaseolina), Choanephora leaf blight (Choanephora infundibulifera, Choanephora trispora), damping-off, stem, root rot and aerial blight (Rhizoctonia solani, Thanatephorus cucumeris), Drechslera blight (Drechslera glycines), frogeye leaf spot (Cercospora sojina), Fusarium root rot (Fusarium spp.), Leptosphaerulina leaf spot (Leptosphaerulina trifolii), Mycoleptodiscus root rot (Mycoleptodiscus terrestris), Neocosmospora stem rot (Neocosmospora vasinfecta, Acremonium spp.), Phomopsis seed decay (Phomopsis spp.), Phyllosticta leaf spot (Phyllosticta sojaecola), Phymatotrichum root rot, cotton root rot (Phymatotrichopsis omnivora, Phymatotrichum omnivorum), pod and stem blight (Diaporthe phaseolorum, Phomopsis sojae), powdery mildew (Microsphaera diffusa), purple seed stain (Cercospora kikuchii), Pyrenochaeta leaf spot (Pyrenochaeta glycines), red crown rot (Cylindrocladium crotalariae, Calonectria crotalariae), red leaf blotch, Dactuliophora leaf spot (Coniothyrium glycines, Dactuliochaeta glycines), rust (Phakopsora pachyrhizi), scab (Spaceloma glycines), Sclerotinia stem rot (Sclerotinia sclerotiorum), Southern blight, Sclerotium blight, damping-off and stem rot (Sclerotium rolfsii, Athelia rolfsii), stem canker (Diaporthe phaseolorum, Diaporthe phaseolorum var. caulivora, Phomopsis phaseoli), Stemphylium leaf blight (Stemphylium botryosum, Pleospora tarda), sudden death syndrome (Fusarium virguliforme, Fusarium solani f. sp. glycines), target spot (Corynespora cassiicola), yeast spot (Nematospora coryli);

On rice: Seedling Diseases—Seedling Blight (Cochliobolus miyabeanus, Curvularia spp., Fusarium spp., Rhizoctonia solani, Sclerotium rolfsii, Athelia rolfsii and others); Seed Box Diseases—Cochliobolus miyabeanus, Gibberella fujikuroi (anam. Fusarium moniliforme), Phoma exigua, Fusarium ssp., Pythium ssp., Rhizopus spp., Tricoderma viride. Rhizoctonia solani, Sclerotium rolfsii; Foliar Diseases—blast (Magnaporthe grisea), brown spot (Cochliobolus miyabeanus), leaf scald (Monographella albescens, Microdochium oryzae, Rhynchosporium oryzae), narrow brown leaf spot (Sphaerulina oryzina, Cercospora janseana, Cercospora oryzae), stackburn or Alternaria leaf spot (Alternaria padwickii), leaf smut (Eballistra oryzae, Entyloma oryzae), eyespot (Drechslera gigantea), white leaf streak (Mycovellosiella oryzae), collar rot (Phomopsis oryzae-sativae), rusts (Puccinia graminis f. sp. oryzae, Uromyces coronatus), Sheath and Culm Diseases—stem rot (Magnaporthe salvinii, Sclerotium oryzae [synanamorph]), sheath blight (Thanatephorus cucumeris, Rhizoctonia solani [anamorph]), sheath spot (Waitea circinata, Rhizoctonia oryzae [anamorph]), aggregate sheath spot (Thanetephorus cucumeris, Rhizoctonia solani [anamorph]), Waitea circinata, Rhizoctonia oryzae [anamorph]), Ceratobasidium oryzae sativae, Rhizoctonia oryzae-sativae [anamorph]), sheath net blotch (Cylindrocladium scoparium), sheath rot (Sarocladium oryzae), crown sheath rot (Gaeumannomyces graminis), Myrothecium blotch (Myrothecium verrucaria), sheath blotch Pyrenochaeta oryzae); Root and Crown Diseases—bakanae (Gibberella fujikuroi, Fusarium moniliforme [anamorph]), root rots (Fusarium spp.); Grain Diseases—false smut (Villosiclava vixens), Udbatta (Balansia oryzae-sativae), glume blight (Epicoccum sorghi), black kernel (Cochliobolus lunatus), minute leaf and grain spot (Cochliobolus miyabeanus), red blotch of grains (Epicoccum nigrum), ear blight (Cochliobolus miyabeanus, Sphaerulina oryzina, Cochliobolus lunatus, Monographella nivalis, Fusarium spp., Phoma spp., Monographella albescens, Magnaporthe salvinii, Cladosporoium spp., Epicoccum sp., Nigrospora spp.);

On sugar beets: Alternaria leaf spot (Alternaria alternate, Alternaria brassicae), anthracnose (Colletrotrichum dematium), Aphanomyces root rot (Aphanomyces cochlioides), Cercospora leaf spot (Cercospora beticola), charcoal rot (Macrophomina paseaolina), Choanephora rot (Choanephora cucurbitarum), damping-off, black leg, black root, and seedling blight (Aphanomyces cochlioides, Cylindrocladium spp., Fusarium spp., Phoma betae, Pleospora betae, Rhizoctonia solani, Thanatephorus cucumeris), Fusarium yellows (Fusarium oxysporum), leaf gall/beet tumor/crown wart (Physoderma leproides), phoma leaf spot and root rot (Phoma betae), cotton root rot (Phymatotrichopsis omnivore), powdery mildew (Erysiphe polygon/, Erysiphe betae), Ramularia leaf spot (Ramularia beticola), Rhizoctonia foliar blight, crown rot, root rot (Rhizoctonia solani), Rhizopus root rot (Rhizopus arrhizus, Rhizopus stolonifera), rust (Uromyces betae), Sclerotinia crown and root rot (Sclerotinia sclerotiorum), seedling rust (Puccini subnitens), southern blight, Sclerotium root rot and stem rot (Sclerotium rolfsii), Stemphylium leaf spot (Stemphylium botryosum), storage rots (Botrytis cinerea, Penicillium spp., Phoma betae), Verticillium wilt (Verticillium albo-atrum) and violet root rot (Helicobasidium brebissonii);

On barley: Anthracnose (Colletotrichum cereale Manns), barley stripe (Pyrenophora graminea), common root rot, crown rot and seedling blight (Cochliobolus sativus, Fusarium culmorum, Fusarium graminearum), dwarf bunt (Tilletia controversa), ergot (Claviceps purpurea), eyespot (Pseudocercosoporella herpotrichoides), halo spot (Pseudoseptoria donacis), kernel blight (Alternaria spp., Arthrinium arundinis, Cochliobolus sativus, Fusarium spp.), Ascochyta leaf spot (Ascochyta spp.), net blotch (Drechslera teres, Pyrenophora teres), powdery mildew (Erysiphe graminis f. sp. hordei, Blumeria graminis), Rhizoctonia root rot (Rhizoctonia solani), crown rust (Puccinia coronata var. hordei), leaf rust (Puccinia hordei), stem rust (Puccinia graminis), stripe rust/yellow rust (Puccinia striiformis f. sp. hordei), scab/head blight (Fusarium spp.), Septoria speckled leaf blotch (Septoria passerinii, Stagonospora avenae f. sp. triticae), sharp eyespot (Rhizoctonia cerealis), covered smut (Ustilago hordei), false loose smut (Ustilago nigra), loose smut (Ustilago nuda), gray snow mold/Typhula blight (Typhula incarnata, Typhula ishikariensis), pink snow mold/Fusarium patch (Microdochium nivale), Ramularia leaf spot of barley (Ramularia collo-cygni), speckled snow mold (Typhula idahoensis), snow scald/Sclerotinia snow mold (Myriosclerotinia borealis, Sclerotinia borealis), southern blight (Sclerotium rollsii), spot blotch (Cochliobolus sativus), Stagonospora blotch (Stagonospora avenae f. sp. triticae, Stagonospora nodorum, Septoria nodorum), take-all (Gaeumannomyces graminis var. tritici), tan spot (Pyrenophora tritici-repentis, Pyrenophora trichostoma) and Verticillium wilt (Verticillium dahliae);

On wheat: Alternaria leaf blight (Alternaria triticina), anthracnose (Glomerella graminicola, Colletotrichum graminicola), Ascochyta leaf spot (Ascochyta tritici), Aureobasidium decay (Microdochium bolleyi, Aureobasidium bolleyi), black head molds, sooty molds (Alternaria spp., Cladosporium spp., Epicoccum spp., Sporobolomyces spp., Stemphylium spp.), black point, kernel smudge (Alternaria spp., Cochliobolus sativus, Cladosporium spp.), Cephalosporium stripe (Hymenula cerealis, Cephalosporium gramineum), common bunt=stinking smut (Tilletia spp.), common root rot (Cochliobolus sativus, Bipolaris sorokiniana, Helminthosporium sativum), cottony snow mold (Coprinus psychromorbidus), crown rot, foot rot, seedling blight, dryland root rot (Fusarium spp., Gibberella spp.), Dilophospora leaf spot, twist (Dilophospora alopecuri), dwarf bunt (Tilletia controversa), ergot (Claviceps purpurea, Sphacelia segetum), eyespot, foot rot, strawbreaker (Tapesia yallundae, Ramulispora herpotrichoides, Pseudocercosporella herpotrichoides, Tapesia acuformis, Ramulispora acuformis, Pseudocercosporella herpotrichoides var. acuformis), false eyespot (Gibellina cerealis), flag smut (Urocystis agropyri), halo spot (Pseudoseptoria donacis, Selenophoma donacis), karnal bunt, partial bunt (Tilletia indica, Neovossia indica), rusts (Puccinia spp.), Leptosphaeria leaf spot (Phaeosphaeria herpotrichoides, Leptosphaeria herpotrichoides, Stagonospora), loose smut (Ustilago spp.), Microscopica leaf spot (Phaeosphaeria microscopica, Leptosphaeria microscopica), Phoma spot (Phoma spp.), pink snow mold, Fusarium patch (Microdochium nivale, Fusarium nivale, Monographella nivalis), Platyspora leaf spot (Clathrospora pentamera, Platyspora pentamera), powdery mildew (Erysiphe graminis f. sp. tritici, Blumeria graminis, Erysiphe graminis, Oidium monilioides), Rhizoctonia root rot (Rhizoctonia solani, Thanatephorus cucumeris), scab, head blight, Fusarium head blight (FHB) (Fusarium spp., Gibberella spp., Microdochium nivale, Monographella nivalis), Sclerotinia snow mold, snow scald (Myriosclerotinia borealis, Sclerotinia borealis), Sclerotium wilt, Southern blight, Sclerotium base rot (Sclerotium rolfsii, Athelia rolfsii), Septoria blotch (Septoria tritici, Mycosphaerella graminicola), sharp eyespot (Rhizoctonia cerealis, Ceratobasidium cereale), speckled snow mold, gray snow mold, Typhula blight (Typhula spp.), spot blotch (Cochliobolus sativus, Bipolaris sorokiniana, Helminthosporium sativum), Stagonospora blotch (Phaeosphaeria spp., Stagonospora spp., Septoria spp.), storage molds (Aspergillus spp., Penicillium spp.), take-all (Gaeumannomyces graminis), tan spot, yellow leaf spot, red smudge (Pyrenophora tritici-repentis, Drechslera tritici-repentis), tar spot (Phyllachora graminis, Linochora graminis) and wheat blast (Magnaporthe grisea);

On peanut: Alternaria leaf blight and leaf spot (Alternaria spp.), anthracnose (Colletotrichum spp.), Aspergillus crown rot (Aspergillus niger), blackhull (Thielaviopsis basicola), Botrytis blight (Botrytis cinerea), Charcoal rot and Macrophomina leaf spot (Macrophomina phaseolina), Choanephora leaf spot (Choanephora spp.), Collar rot (Lasiodiplodia theobromae), Cylindrocladium black rot and leaf spot (Cylindrocladium spp., Calonectria spp.), damping-off (Aspergillus spp., Fusarium spp., Rhizoctonia spp., Rhizopus spp.), Drechslera leaf spot (Bipolaris spicifera), Fusarium wilt and peg/root rot (Fusarium spp.), early leaf spot (Cercospora arachidicola), late leaf spot (Phaeoisariopsis personata, Cercosporidium personatum), melanosis (Stemphylium botryosum), Myrothecium leaf blight (Myrothecium roridum), Pepper spot and scorch (Leptosphaerulina crassiasca), Pestalotiopsis leaf spot (Pestalotiopsis arachidis), Phoma leaf blight (Phoma microspore), Phomopsis foliar blight and leaf spot (Phomopsis spp.), Phyllosticta leaf spot (Phyllosticta spp.), Phymatotrichum root rot (Phymatotrichopsis omnivore, Fusarium scirpi), pod rot (Fusarium spp., Rhizoctonia spp.), powdery mildew (Oidium arachidis), Rhizoctonia foliar blight, peg and root rot (Rhizoctonia solani), rust (Puccinia arachidis), scab (Sphaceloma arachidis), Sclerotinia blight (Sclerotinia spp.), stem rot/southern blight (Sclerotium rolfsii), Verticillium wilt (Verticillium spp.), web blotch/net blotch (Phoma arachidicola, Didymosphaeria arachidicola), yellow mold (Aspergiillus spp.), and zonate leaf spot (Cristulariella moricola);

On other grain crops (including but not limited to rye, sorghum, oat, and triticale): Anthracnose (Colletotrichum spp.) black head molds (Alternaria spp., Cladosporium spp., Sporobolomyces spp., Stemphylium spp.), black point (Bipolaris spp., Fusarium spp.), bunt/stinking smut (Tilletia spp.), Cephalosporium stripe (Hymenula cerealis), Common root rot and seedling blight (Bipolaris sorokiniana), winter crown rot (Coprinus psychromorbidus), Dilophospora leaf spot (Dilophospora alopecuri), dwarf bunt (Tilletia controversa), ergot (Claviceps purpurea), Fusarium root rot (Fusarium culmorum), halo spot (Pseudoseptoria donacis), karnal bunt (Neovossia indica), leaf streak (Cercosporidium graminis), Leptosphaeria leaf spot (Phaeosphaeria herpotrichoides), loose smut (Ustilago tritici), pink snow mold (Fusarium spp.), powdery mildew (Erysiphe spp.), scab (Fusarium graminearum), Septoria leaf blotch and tritici blotch (Septoria spp.), sharp eyespot and Rhizoctonia root rot (Rhizoctonia cerealis), snow mold (Typhula spp.), spot blotch (Bipolaris sorokiniana), glume blotch (Septoria nodorum), stalk/stripe smut (Urocystis occulta), stem rust (Puccinia graminis), eyespot/foot rot (Pseudocercosporella herpotrichoides), stripe rust (Puccinia striiformis), take-all (Gaeumannomyces graminis), and tan spot (Pyrenophora tritici-repentis).

Compound I has been found to have significant fungicidal effects on phytopathogenic fungi of agriculturally useful row crops. These diseases include Puccinia polysora, which causes brown rust of corn; Cercospora zeae-maydis, which causes grey leaf spot of corn; Magnaporthe grisea, which causes rice panicle blast; Cercospora beticola, which causes cercospora leaf spot of sugar beet; Pyrenophora teres, which causes net blotch of barley; Blumeria graminis f sp. hordei, which causes powdery mildew of barley; Blumeria graminis f. sp. tritici, which causes powdery mildew of wheat; Ramularia collo-cygni, which causes Ramularia leaf spot of barley; Sclerotium rolfsii, which causes white mold of peanut; Cercospora arachidicola, which causes early leaf spot of peanut; Cercosporidium personatum, which causes late leaf spot of peanut; and Cercospora sojina, which causes frogeye leaf spot of soybean, particularly for agricultural use. Compound I is particularly effective for use with agricultural crops and horticultural plants.

Compound I has a broad range of efficacy as a fungicide. The exact amount of the active material to be applied is dependent not only on the specific active material being applied, but also on the particular action desired, the fungal species to be controlled, and the stage of growth thereof, as well as the part of the plant or other product to be contacted with the compound. Thus, compound I, and formulations containing the same, may not be equally effective at similar concentrations or against the same fungal species.

Compound I is effective in use with plants in a disease-inhibiting and phytologically acceptable amount. The term “disease-inhibiting and phytologically acceptable amount” refers to an amount of a compound that kills or inhibits the plant disease for which control is desired, but is not significantly toxic to the plant. This amount will generally be from about 0.1 to about 1000 ppm (parts per million), with 1 to 500 ppm being preferred. The exact concentration of compound required varies with the fungal disease to be controlled, the type of formulation employed, the method of application, the particular plant species, climate conditions, and the like. A suitable application rate is typically in the range from about 0.10 to about 4 pounds/acre (about 0.01 to 0.45 grams per square meter, g/m²).

Any range or desired value given herein may be extended or altered without losing the effects sought, as is apparent to the skilled person for an understanding of the teachings herein.

### EXAMPLES

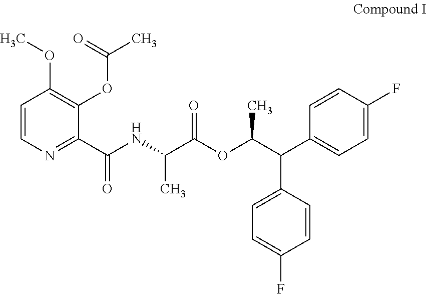 [SMILES: COc1ccnc(C(=O)N[C@@H](C)C(=O)O[C@@H](C)C(c2ccc(F)cc2)c2ccc(F)cc2)c1OC(C)=O]

Field Assessment of Puccinia polysora (PUCCPY) in Corn:

A fungicidal treatment containing Compound I, applied in an EC formulation and tank mixed with an adjuvant (Trycol, 50% w/w at 0.2% v/v), was sprayed on corn plants (ZEAMX, P30R50 variety) at growth stage 35 (stem elongation prior to tassel emergence) at rates of 50, 100, and 150 grams of active ingredient per hectare (g ai/ha). The experimental plots were inoculated with brown rust 24 hr after application. The treatment was part of an experimental trial designed as a randomized complete block with four replications and a plot of approximately 1×3 m. Compound I was applied at water volume of 200 L/ha, using a backpack precision plot sprayer (BKPCKAIR, 2 and 3 m band width, Flat Fan XR110.015 Nozzle) and pressurized at 30 psi.

Disease severity (percentage of visual diseased foliage on whole plot) was assessed five times during the trial (20-50 days after application, DAA). The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results are given in Table 1.

Field Assessment of Cercospora zeae-Maydis (CERCZM) in Corn:

A fungicidal treatment containing Compound I, applied in an EC formulation and tank mixed with an adjuvant (Trycol, 50% w/w at 0.2% v/v), was sprayed on corn plants (ZEAMX, Formula variety) at growth stage 35 (stem elongation prior to tassel emergence) at rates of 50, 100, and 150 grams of active ingredient per hectare (g ai/ha). The experimental plots were inoculated with grey leaf spot 24 hr after application. The treatment was part of an experimental trial designed as a randomized complete block with four replications and a plot of approximately 1×3 m. Compound I was applied at water volume of 200 L/ha, using a backpack precision plot sprayer (BKPCKAIR, 2 and 3 m band width, Flat Fan XR110.015 Nozzle) and pressurized at 30 psi.

Disease severity (percentage of visual diseased foliage on whole plot) was assessed five times during the trial (22-50 days after application, DAA). The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results are given in Table 1.

Field assessment of Magnaporthe grisea (PYRIOR) in rice:

A fungicidal treatment containing an EC formulation of compound I plus an adjuvant (Trycol, 50% w/w at 0.2% v/v), was sprayed on rice plants (ORYSP) twice, the first application at 70 days after transplant (DAT) and the second application on a 10 day interval. Compound I was applied at rates of 50, 100, 150 and 200 grams of active ingredient per hectare (g ai/ha). The experimental plots were inoculated with Magnaporthe grisea 2 days after the first application (70 DAT). The treatment was part of an experimental trial designed as a randomized complete block with four replications and a plot of approximately 2×1 m. Compound I was applied at a water volume of 1000 L/ha based on seedling sizes.

Disease severity was recorded as a percentage of visual diseased foliage on whole plot. Rice blast infection was assessed four times, 7 days after application A (DAAA) plus 7, 14 and 21 DAAB. The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results are given in Table 1.

Field Assessment of Ramularia collo-Cygni (RAMUCC) on Barley:

A fungicidal treatment containing a 5% EC formulation of compound I, tanked mixed with an adjuvant (Trycol, 50% w/w at 0.1% v/v), was sprayed on barley plants (winter barley; Cassia variety) at BBCH 33 growth stage of winter barley (5% infection on L5 at application), under natural infection of Ramularia leaf spot of barley. Compound I was applied at rates of 75, 100 and 150 grams of active ingredient per hectare (g ai/ha). The treatment was part of an experimental trial designed as a randomized complete block with four replications and a plot of approximately 1×2 m. Compound I was applied at water volume of 200 L/ha, using a backpack precision plot sprayer (BKPCKAIR, F110-03 Nozzle) and pressurized at 180 kPa.

Disease severity was recorded as a percentage of visual diseased foliage on whole plot. Ramularia leaf spot of barley infection was assessed three times at 7, 14 and 21 days after the last application. The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results are given in Table 1.

Field Assessment of Cercospora beticola (CERCBE) on Sugar Beet:

Assessment of compound I of CERCBE on sugar beet was performed in two separate field trials. In the first trial, a fungicidal treatment containing an EC and SC formulations of compound I by itself and in combination with an adjuvant (Phase II, 50% w/w at 0.5% v/v) was sprayed on sugar beet plants (BEAVA, Frieda variety) six times during the course of 7 weeks at the 18-39 growth stages of sugar beet. The treatments were applied at rates of 75 and 150 grams active ingredient per hectare (g ai/ha) under natural infection with CERCBE. The treatment was part of an experimental trial designed as a randomized complete block with four replications and a plot of approximately 1×2 m. Compound I was applied at water volume of 500 L/ha, using a backpack plot sprayer (AI Twin Jet Nozzle).

In the second trial, a fungicidal treatment containing an EC and SC formulations of compound I by itself and in combination with an adjuvant (Phase II, 50% w/w at 0.5% v/v) was sprayed on sugar beet plants (BEAVA) five times during the course of 4 weeks at the 36-49 growth stages of sugar beet. The treatments were applied at rates of 75 and 150 grams active ingredient per hectare (g ai/ha) under natural infection with CERCBE. The treatment was part of an experimental trial designed as a randomized complete block with four replications and a plot of approximately 2×2 m. Compound I was applied at water volume of 500 L/ha, using a backpack plot sprayer (Flatfan Nozzle).

Disease severity was recorded as a percentage of visual diseased foliage on whole plot. Cercospora leaf spot infection was assessed three times at 7, 14 and 21 days after the last application. The disease infection was recorded following EPPO PP 1/1 (4) guideline prescriptions. Area under the disease progress curve (AUDPC) was calculated for each plot using the sets of recorded severity data. Relative AUDPC (% control based on AUDPC) was calculated as percent of the nontreated control and averaged over both field trials. Results are given in Table 2.

Field Assessment of Pyrenophora teres (PYRNTE) on Barley:

A fungicidal treatment containing an EC formulation of compound I, tanked mixed with an adjuvant (Trycol, 50% w/w at 0.1% v/v), was sprayed on barley plants (spring barley; Scarlett variety) twice, the first application at BBCH 37-43 growth stages of spring barley (0.01% infection on L1 at application) and the second application at growth stages 53-57 of spring barley (6.25% infection at application). Compound I was applied at rates of 75, 100 and 150 grams of active ingredient per hectare (g ai/ha). The experimental plots were inoculated with net blotch of barley (1,000,000 spores/mL) at growth stage 39 of spring barley 1 day after the first inoculation. The treatment was part of an experimental trial designed as a randomized complete block with four replications and a plot of approximately 1×2 m. Compound I was applied at water volume of 200 L/ha, using a backpack precision plot sprayer (BKPCKAIR, TeeJet 8004EVS Nozzle) and pressurized at 120 kPa.

A replicated field trial also demonstrated useful levels of control of Pyrenophora teres on barley. A fungicidal treatment containing an EC formulation of compound I, tanked mixed with an adjuvant (Trycol, 50% w/w at 0.2% v/v), was sprayed on barley plants at rates of 50, 100 and 150 grams of active ingredient per hectare (g ai/ha). Compound I was applied at a water volume of 200 L/ha under natural infection of Pyrenophora teres.

Disease severity was recorded as a percentage of visual diseased foliage on whole plot. Net blotch of barley infection was assessed three times at 7, 14 and 21 days after the last application. The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results for both trials are given in Table 3.

Greenhouse Assessment of Blumeria graminis f sp. hordei (ERYSGH) on Barley:

In greenhouse studies, technical grades of material were dissolved in acetone, which were then mixed with nine volumes of water containing 100 ppm of Triton X-100. The fungicide formulations were applied onto seedling plants using an automated booth sprayer to run off. All sprayed plants were allowed to dry prior to further handling. Test plants were inoculated with powdery mildew of barley 1-day post application. When disease symptoms were fully expressed on the untreated plants, infection levels were assessed on a scale of 0 to 100 percent disease severity. Percent disease control was calculated using the ratio of disease severity on treated plants relative to untreated plants. Results are given in Table 4.

Field Assessment of Blumeria graminis f sp. Tritici (ERYSGT) on Wheat:

A fungicidal treatment containing either an EC or SC formulation of compound I tank mixed with an adjuvant (Agnique BP420, 50% w/w at 0.3% v/v) was sprayed twice on winter wheat plants (TRZAW, Simeto variety) of approximately 0.3 m in height. The treatments were applied at rates of 5, 20, 40, 60, 80 and 120 grams active ingredient per hectare (g ai/ha) under natural powdery mildew infection. The treatment was part of an experimental trial designed as a randomized complete block with four replications and a plot of approximately 2×5 m. Compound I was applied at water volume of 200 L/ha, using a backpack plot sprayer (AZO, compressed air).

Disease severity was recorded as a percentage of visual diseased foliage on whole plot. ERYSGT infection was assessed three times at 12, 19 and 26 days after the last application. The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results are given in Table 5.

In each case of Tables 1-5 the rating scale of percent control based on AUDPC is as follows:

| % Control | Rating |
|---|---|
| 76-100 | A |
| 51-75 | B |
| 26-50 | C |
| 1-25 | D |
| Not tested | E |

TABLE 1
Biological Activity - Disease Control^{a} by Compound I on Fungal
Diseases of Row Crops with Trycol Adjuvant (50% w/w at 0.2% v/v).

| Rate | | | | |
|---|---|---|---|---|
| (g ai/ha)^{b} | PUCCPY^{c} | CERCZM^{d} | PYRIOR^{e} | RAMUCC^{f} |
| 50 | C | B | C | E |
| 75 | E | E | E | C |
| 100 | B | B | C | C |
| 150 | B | B | B | B |
| 200 | E | E | B | E |

^{a}Percent control based on Area Under Disease Progression Curve (AUDPC)
^{b}Grams of active ingredient per hectare
^{c}Brown rust of corn - Puccinia polysora
^{d}Grey leaf spot of corn - Cercospora zeae-maydis
^{e}Rice pannicle blast - Magnaporthe grisea
^{f}Ramularia leaf spot of barley - Ramularia collo-cygni

TABLE 2
Efficacy of Compound I against Cercospora Leaf Spot Infection
on Sugar Beet (CERCBE, Cercospora beticola).

| | Rate | | |
|---|---|---|---|
| Formulation | (g ai/ha)^{a} | Adjuvant^{b} | % Control^{c} |
| EC | 75 | N | B |
| EC | 75 | Y | B |
| EC | 150 | N | A |
| SC | 75 | N | B |
| SC | 75 | Y | B |
| SC | 150 | N | A |

^{a}Grams of active ingredient per hectare
^{b}Phase II (50% w/w at 0.5% v/v)
^{c}Percent control based on Area Under Disease Progression Curve (AUDPC)

TABLE 3
Efficacy of Compound I against Net Blotch of Barley
(PYRNTE, Pyrenophora teres).

| Rate | | % Control^{c} | % Control^{c} |
|---|---|---|---|
| (g ai/ha)^{a} | Adjuvant^{b} | Trial 1 | Trial 2 |
| 50 | Y | E | B |
| 75 | Y | B | E |
| 100 | Y | B | B |
| 150 | Y | B | B |

^{a}Grams of active ingredient per hectare
^{b}Trycol (50% w/w at 0.2% v/v)
^{c}Percent control based on Area Under Disease Progression Curve (AUDPC)

TABLE 4
Efficacy of Compound I against Powdery Mildew of Barley
(ERYSGH, Blumeria graminis f. sp. hordei).

| Rate | |
|---|---|
| (ppm)^{a} | % Control^{b} |
| 100 | A |
| 25 | A |
| 6.25 | A |
| 1.56 | A |
| 0.39 | B |

^{a}Parts per million
^{b}Percent control calculated using the ratio of disease severity on treated plants relative to untreated plants

TABLE 5
Efficacy of Compound I against Powdery Mildew of Wheat (ERYSGT,
Blumeria graminis f. sp. tritici) Tank Mixed with Agnique BP-420
(50% w/w at 0.3% v/v).

| Rate | | % |
|---|---|---|
| (g ai/ha)^{a} | Formulation | Control^{b} |
| 5 | EC | C |
| 5 | SC | C |
| 20 | EC | A |
| 20 | SC | B |
| 40 | EC | A |
| 40 | SC | A |
| 60 | EC | A |
| 60 | SC | A |
| 80 | EC | A |
| 80 | SC | A |
| 120 | EC | A |
| 120 | SC | A |

^{a}Grams of active ingredient per hectare
^{b}Percent control based on Area Under Disease Progression Curve (AUDPC)

Field Assessment of Sclerotium rolfsii (SCLORO) in Two Trials in Peanut:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed on peanut plants (ARHHY, GA09B variety) at rates of 50, 75, 100, and 150 grams of active ingredient per hectare (g ai/ha) in two trials. Four applications, at two week intervals were made to each trial, starting at growth stage BBCH66 and continuing through BBCH84. The experimental plots were conducted with natural infestation of the pathogen. The treatment was part of an experimental trial designed as a randomized complete block (RCB) with four replications and a plot of approximately 6×40 ft. Compound I was applied at water volume of 15 or 18.8 gallons per acre (gal/acre), using a backpack sprayer (carbon dioxide (CO₂) or Tractor sprayer, Flat Fan XR80015 or 11002 nozzles) and pressurized at 35 or 40 psi.

Percent stem incidence (percent of stems with any disease, based on 80 stems counted per plot) was assessed at 42 days after application D (42 DAAD). Results are given in Table 6.

Yield of peanut (ARHHY, Arachis hypogaea) was assessed at 49 days after application D (49 DAAD) and was calculated as a percentage of the untreated control. Results are given in Table 7.

Field Assessment of Cercospora arachidicola (MYCOAR) in Peanut:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed in two trials on peanut plants (ARHHY, GA09B and GA13M varieties). Seven applications, beginning at growth stage BBCH73 and following at 14 day intervals through growth stage BBCH88, were made at rates of 50, 75, 100, and 150 g ai/ha. The experimental plots were conducted with natural infestation of the pathogen. The treatment was part of an experimental trial designed as a randomized complete block (RCB) with four replications and a plot of approximately 6.67×20 ft. Compound I was applied at water volume of 15 gal/acre, using a backpack sprayer CO₂, HC solid TX-8 nozzles and pressurized at 50 psi.

Disease severity (percentage of visual diseased foliage on whole plot) was assessed four times during the trial (11-53 DAA4). Area under the disease progress curve (AUDPC) was calculated for each plot using the sets of recorded severity data. Relative % control (% control based on AUDPC) was calculated as percent of the untreated control. Results are given in Table 8.

Field Assessment of Cercosporidium personatum (MYCOBE) in Peanut:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed in five trials on peanut plants (ARHHY, GA09B, GA13M, or GA06G varieties). Five to seven applications, beginning at growth stages BBCH51-61 and following at 14 day intervals through growth stages BBCH73-89, were made at rates of 50, 75, 100, and 150 g ai/ha. The experimental plots were conducted with natural infestation of the pathogen. The treatment was part of an experimental trial designed as a randomized complete block (RCB) with four replications and a plot of approximately 6-6.7×20-30 ft. Compound I was applied at water volume of 15, 18 or 18.5 gal/acre, using a CO₂ backpack sprayer (HC solid TXVK-8, TX8, or TX10 nozzles) and pressurized at 38-50 psi.

Disease severity (percentage of visual diseased foliage on whole plot) was assessed three or four times during the trials. Area under the disease progress curve (AUDPC) was calculated for each plot using the sets of recorded severity data. Relative % control (% control based on AUDPC) was calculated as percent of the untreated control. Results are given in Table 9.

Field Assessment of Cercospora sojina (CERSO) in Soybean:

A fungicidal treatment containing Compound I, applied in an SC formulation (MSO built-in) and tank mixed with an adjuvant (Agnique BP-420, 50% w/w at 0.2% v/v or Adsee C80W 80%), was sprayed in two trials on soybean plants (GLYMX, Mycogen 5N490R2 and Mycogen 5N49 varieties). One application at growth stage BBCH64-70 was made at rates of 50, 75, 100, and 150 g ai/ha. The experimental plots were conducted with natural infestation of the pathogen. The treatment was part of an experimental trial designed as a randomized complete block (RCB) with four replications and a plot of approximately 6.3×28-30 ft. Compound I was applied at water volume of 15 gal/acre, using a CO₂ backpack sprayer (HC solid TX8 or HC disk nozzles) and pressurized at 32 or 50 psi.

Percent disease severity (percentage of disease severity in the upper canopy of the plot) was assessed three or four times during the trials. Results are given in Table 10.

Percent severity (percentage of disease severity in the upper canopy of the plot) was assessed three or four times during the trials. Area under the disease progress curve (AUDPC) was calculated for each plot using the sets of recorded severity data. Resulting AUDPC values were used to calculate percent of untreated values. Results are given in Table 11.

Soybean (GLYMX, Glycine max) was harvested at crop maturity (86 or 95 DAAA respectively), with yield reported as a percentage of the untreated control. Results are given in Table 12.

TABLE 6
Formulation Comparison of Compound I with MSO or Tank-Mixed
with Agnique BP-420 of Calculated Percent Stem Incidence of
White Mold of Peanut (SCLORO, Sclerotium rolfsii)

| | | Calc Percent Stem |
|---|---|---|
| | | Incidence of |
| Compound I^{a} | Adjuvant^{a or b} | SCLORO |
| 50 | MSO, 100^{a} | 39.1 |
| 75 | MSO, 150^{a} | 33.0 |
| 100 | MSO, 200^{a} | 28.2 |
| 150 | MSO, 300^{a} | 24.7 |
| 50 | Agnique BP420, 200^{b} | 41.6 |
| 75 | Agnique BP420, 300^{b} | 33.2 |
| 100 | Agnique BP420, 400^{b} | 27.9 |
| 150 | Agnique BP420, 600^{b} | 29.6 |
| 100 | Adsee C80W 80%, 250^{a} | 28.9 |
| Untreated | | 41.8 |

^{a}Rate in g/ha
^{b}Rate in mL/ha

TABLE 7
Formulation Comparison of Compound I with MSO or Tank-Mixed
with Agnique BP-420 on Peanut (ARHHY, Arachis hypogaea)
Yield Percent of Untreated

| | | ARHHY Yield |
|---|---|---|
| | | Percent of |
| Compound I^{a} | Adjuvant^{a or b} | Untreated |
| 50 | MSO, 100^{a} | 104.9 |
| 75 | MSO, 150^{a} | 112.8 |
| 100 | MSO, 200^{a} | 115.7 |
| 150 | MSO, 300^{a} | 131.5 |
| 50 | Agnique BP420, 200^{b} | 96.4 |
| 75 | Agnique BP420, 300^{b} | 113.9 |
| 100 | Agnique BP420, 400^{b} | 118.0 |
| 150 | Agnique BP420, 600^{b} | 130.0 |
| 100 | Adsee C80W 80%, 250^{a} | 122.0 |
| Untreated | | 100 |

^{a}Rate in g/ha
^{b}Rate in mL/ha

TABLE 8
Formulation Comparison of Compound I with MSO or Tank-Mixed
with Agnique BP-420 of Calculated Percent Control of Early Leaf
Spot of Peanut (MYCOAR, Cercospora arachidicola)

| | | Calc Percent |
|---|---|---|
| | | Control of |
| Compound I^{a} | Adjuvant^{a or b} | MYCOBE |
| 50 | MSO, 100^{a} | 32.0 |
| 75 | MSO, 150^{a} | 36.3 |
| 100 | MSO, 200^{a} | 44.4 |
| 150 | MSO, 300^{a} | 52.3 |
| 50 | Agnique BP420, 200^{b} | 31.5 |
| 75 | Agnique BP420, 300^{b} | 35.6 |
| 100 | Agnique BP420, 400^{b} | 44.8 |
| 150 | Agnique BP420, 600^{b} | 57.7 |
| 100 | Adsee C80W 80%, 250^{a} | 40.3 |

^{a}Rate in g/ha
^{b}Rate in mL/ha

TABLE 9
Formulation Comparison of Compound I with MSO or Tank-Mixed
with Agnique BP-420 of Calculated Percent Control of Late Leaf
Spot of Peanut (MYCOBE, Cercosporidium personatum)

| | | Calc Percent |
|---|---|---|
| | | Control of |
| Compound I^{a} | Adjuvant^{a or b} | MYCOBE |
| 50 | MSO, 100^{a} | 24.0 |
| 75 | MSO, 150^{a} | 26.8 |
| 100 | MSO, 200^{a} | 29.0 |
| 150 | MSO, 300^{a} | 38.5 |
| 50 | Agnique BP420, 200^{b} | 28.5 |
| 75 | Agnique BP420, 300^{b} | 30.0 |
| 100 | Agnique BP420, 400^{b} | 36.0 |
| 150 | Agnique BP420, 600^{b} | 44.7 |
| 100 | Adsee C80W 80%, 250^{a} | 26.9 |

^{a}Rate in g/ha
^{b}Rate in mL/ha

TABLE 10
Formulation Comparison of Compound I with MSO or Tank-Mixed
with Agnique BP-420 on Frogeye Leaf Spot (CERCSO, Cercospora
sojina) Percent Visual Severity

| | | Percent Visual |
|---|---|---|
| | | Severity of |
| Compound I^{a} | Adjuvant^{a or b} | CERCSO |
| 50 | MSO, 100^{a} | 6.5 |
| 75 | MSO, 150^{a} | 3.6 |
| 100 | MSO, 200^{a} | 4.3 |
| 150 | MSO, 300^{a} | 3.3 |
| 50 | Agnique BP420, 200^{b} | 5.6 |
| 75 | Agnique BP420, 300^{b} | 4.2 |
| 100 | Agnique BP420, 400^{b} | 4.5 |
| 150 | Agnique BP420, 600^{b} | 3.3 |
| 100 | Adsee C80W 80%, 250^{a} | 4.5 |
| Untreated | | 8.6 |

^{a}Rate in g/ha
^{b}Rate in mL/ha

TABLE 11
Formulation Comparison of Leaftop Severity as a Percentage of
Untreated (AUDPC) of Compound I with MSO or Tank-Mixed with
Agnique BP-420 on Frogeye Leaf Spot (CERSO, Cercospora sojina)

| | | CERCSO |
|---|---|---|
| | | Percent of |
| | | Untreated |
| Compound I^{a} | Adjuvant^{a or b} | (AUDPC) |
| 50 | MSO, 100^{a} | 73.8 |
| 75 | MSO, 150^{a} | 62.9 |
| 100 | MSO, 200^{a} | 52.4 |
| 150 | MSO, 300^{a} | 53.5 |
| 50 | Agnique BP420, 200^{b} | 62.0 |
| 75 | Agnique BP420, 300^{b} | 63.1 |
| 100 | Agnique BP420, 400^{b} | 61.6 |
| 150 | Agnique BP420, 600^{b} | 48.4 |
| 100 | Adsee C80W 80%, 250^{a} | 58.3 |

^{a}Rate in g/ha
^{b}Rate in mL/ha

TABLE 12
Formulation Comparison of Yield of Soybean (GLXMA, Glycine max)
as a Percentage of Untreated with Compound I with MSO or
Tank-Mixed with Agnique BP-420

| | | GLXMA Yield |
|---|---|---|
| | | Percent of |
| Compound I^{a} | Adjuvant^{a or b} | Untreated |
| 50 | MSO, 100^{a} | 108.0 |
| 75 | MSO, 150^{a} | 114.6 |
| 100 | MSO, 200^{a} | 113.4 |
| 150 | MSO, 300^{a} | 112.9 |
| 50 | Agnique BP420, 200^{b} | 117.0 |
| 75 | Agnique BP420, 300^{b} | 119.2 |
| 100 | Agnique BP420, 400^{b} | 117.6 |
| 150 | Agnique BP420, 600^{b} | 114.8 |
| 100 | Adsee C80W 80%, 250^{a} | 115.3 |
| Untreated | | 100.0 |

^{a}Rate in g/ha
^{b}Rate in mL/ha

What is claimed is:

1. A method of controlling fungal diseases in a row crop that is at risk of being diseased comprising the steps of: contacting at least a portion of a plant and/or an area adjacent to a plant with a composition including compound I. 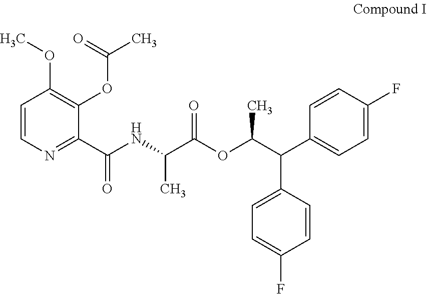 [SMILES: COc1ccnc(C(=O)N[C@@H](C)C(=O)O[C@@H](C)C(c2ccc(F)cc2)c2ccc(F)cc2)c1OC(C)=O]
wherein said compound is effective against a plant pathogen.

2. The method of claim 1 wherein the composition is

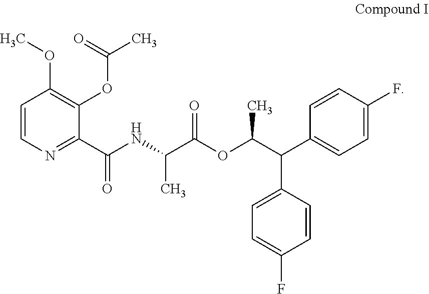 [SMILES: COc1ccnc(C(=O)N[C@@H](C)C(=O)O[C@@H](C)C(c2ccc(F)cc2)c2ccc(F)cc2)c1OC(C)=O]

3. The method of claim 1, wherein the composition further includes at least one additional agriculturally active ingredient selected from the group consisting of: an insecticide, an herbicide, and a fungicide.

4. The method of claim 1, wherein the fungal pathogen is selected from the group consisting of the causal agents of: brown rust of corn (Puccinia polysora), grey leaf spot of corn (Cercospora zeae-maydis), rice panicle blast (Magnaporthe grisea), Cercospora leaf spot of sugar beet (Cercospora beticola), net blotch of barley (Pyrenophora teres), powdery mildew of barley (Blumeria graminis f. sp. tritici), Ramularia leaf spot of barley (Ramularia collo-cygni), powdery mildew of wheat (Blumeria graminis f. sp. tritici), white mold of peanut (Sclerotium rolfsii), early leaf spot of peanut (Cercospora arachidicola), late leaf spot of peanut (Cercosporidium personatum), and frogeye leaf spot of soybean (Cercospora sojina).

5. The method of claim 2, wherein the composition further includes at least one additional agriculturally active ingredient selected from the group consisting of: an insecticide, an herbicide, and a fungicide.

6. The method of claim 2, wherein the fungal pathogen is selected from the group consisting of the causal agents of: brown rust of corn (Puccinia polysora), grey leaf spot of corn (Cercospora zeae-maydis), rice panicle blast (Magnaporthe grisea), Cercospora leaf spot of sugar beet (Cercospora beticola), net blotch of barley (Pyrenophora teres), powdery mildew of barley (Blumeria graminis f. sp. tritici), Ramularia leaf spot of barley (Ramularia collo-cygni), powdery mildew of wheat (Blumeria graminis f. sp. tritici), white mold of peanut (Sclerotium rolfsii), early leaf spot of peanut (Cercospora arachidicola), late leaf spot of peanut (Cercosporidium personatum), and frogeye leaf spot of soybean (Cercospora sojina).
